(19) United States
(12) Patent Application Publication
(10) Pub. No.: US 2026/0320037 A1
(43) Pub. Date: Oct. 15, 2026

(54) DATA PROCESSING METHOD, TASK SCHEDULING METHOD, APPARATUS, AND STORAGE MEDIUM

(71) Applicants: Beijing BOE Technology Development Co., Ltd., Beijing (CN); BOE Technology Group Co., Ltd., Beijing (CN)

(72) Inventors: Rui Guan, Beijijg (CN); Ning Zhang, Beijijg (CN); Wen He, Beijijg (CN); Lin Fan, Beijijg (CN)

(73) Assignees: Beijing BOE Technology Development Co., Ltd., Beijing (CN); BOE Technology Group Co., Ltd., Beijing (CN)

(21) Appl. No.: 19/476,273

(22) PCT Filed: May 27, 2024
(86) PCT No.: PCT/CN2024/095492

§ 371 Date: Oct. 17, 2025

(30) Foreign Application Priority Data
Jun. 25, 2023 (CN) 202310753836.8

(51) Int. Cl. G06F 16/242; G06F 3/04817; G06F 9/50; G06F 16/2455

(52) U.S. Cl. CPC G06F 16/2433; G06F 3/04817; G06F 9/5038; G06F 16/2455

(57) ABSTRACT

A data processing method is provided, applied to a big data platform including at least two different data sources. The method includes: presenting a data processing task page, and acquiring a SQL associated query statement in response to an input operation of a user on the data processing task page, the SQL associated query statement including a data source information of a plurality of first to-be-processed data tables, where at least two of the plurality of first to-be-processed data tables are from different data sources; acquiring a second to-be-processed data table based on the data source information; replacing the data source information of the first to-be-processed data table in the SQL associated query statement with a data table information corresponding to the second to-be-processed data table, so as to obtain an executable SQL query statement; and executing the executable SQL query statement to obtain a query result.

### TECHNICAL FIELD

The present disclosure relates to a field of data processing, in particular to a data processing method, a task scheduling method, an apparatus, and a storage medium.

### BACKGROUND

With the advent of the big data era, enterprises have begun to uniformly store, manage, analyze, and process data generated in production and operation processes using big data platforms. When storing data, a single enterprise may store data in different data sources according to requirements. However, when analyzing data, it is necessary to fuse data stored in different data sources together for querying and analysis. Generally, ETL (extract, transform, load) tools may be used to synchronize data from various data sources into a certain data warehouse for analysis. However, this method requires pre-synchronization of data, which not only involves a complex and time-consuming process but also results in the synchronized data becoming historical data, making it impossible to realize real-time data computation and analysis.

### SUMMARY

The present disclosure provides a data processing method, a task scheduling method, an apparatus, and a storage medium to solve the shortcomings in the related art.

According to a first aspect of embodiments of the present disclosure, a data processing method is provided, where the method is applied to a big data platform including at least two different data sources, and the method includes:
presenting a data processing task page, and acquiring a SQL associated query statement in response to an input operation of a user on the data processing task page, the SQL associated query statement including a data source information of a plurality of first to-be-processed data tables, where at least two of the plurality of first to-be-processed data tables are from different data sources;
acquiring a second to-be-processed data table based on the data source information;
replacing the data source information of the first to-be-processed data table in the SQL associated query statement with a data table information corresponding to the second to-be-processed data table, so as to obtain an executable SQL query statement; and
executing the executable SQL query statement to obtain a query result.

In some implementations, the data processing method is implemented based on a PySpark framework.

In some implementations, after obtaining the query result, the method further includes:
determining a processing condition for processing the query result based on the input operation of the user;
processing the query result based on the processing condition to obtain a processing result; and
adding a column to the query result and representing the processing result in the column.

In some implementations, after obtaining the query result, the method further includes:
determining a target database for storing the query result and a name of data table for storing the query result based on a configuration operation of the user;
in a case that the target database does not include a data table corresponding to the name of data table, creating a data table corresponding to the name of data table; and
in a case that the target database includes a data table corresponding to the name of data table, determining an output mode based on a selection operation of the user, and writing the query result into the data table of the target database in the output mode.

According to a second aspect of embodiments of the present disclosure, a task scheduling method is provided, where the method is applied to a big data platform, and the method includes:
representing a task scheduling page, and creating a scheduling task based on an input operation of a user on the task scheduling page;
determining a plurality of target data tasks of the scheduling task from a plurality of pre-created candidate data tasks based on a selection operation of the user, where the candidate data task includes a data processing task, and the data processing task is implemented by using the data processing method according to any one of the above items;
representing icons of the plurality of target data tasks on the task scheduling page;
determining an execution order for the plurality of target data tasks in the scheduling task based on a moving operation of a user to the icons; and
executing the plurality of target data tasks in the scheduling task according to the execution order.

In some implementations, the candidate data task further includes a data integration task, and the method further includes:
determining a data integration task name, a data source information and a data destination information based on an operation information of the user on a data integration page; and
creating a data integration task corresponding to the data integration task name based on the data source information and the data destination information.

In some implementations, the method further includes:
based on a selection operation of the user on an icon, representing a development page of a target data task corresponding to the icon; and
in response to detecting a modification operation of the user on the development page, saving a modified target data task.

In some implementations, the input operation includes an initial run time of the scheduling task; and
the executing the plurality of target data tasks in the scheduling task according to the execution order includes:
executing, in response to a current time reaching time instant at which the scheduling task is to run for the first time, the plurality of target data tasks in the scheduling task according to the execution order, and acquiring a running status of each target data task;
in a case that the running status is an error status, stopping executing the scheduling task and returning a status of the scheduling task as an error status; and
in a case that the plurality of target data tasks are executed in the execution order, returning the status of the scheduling task as a completed status.

In some implementations, the method further includes:
representing, based on a selection operation of the user, a corresponding scheduling task template on a scheduling task template page;
acquiring a configuration information for the scheduling task template by the user; and
generating a scheduling task matching the configuration information based on the scheduling task template.

According to a third aspect of embodiments of the present disclosure, a data processing apparatus is provided, where the apparatus is applied to a big data platform including at least two different data sources, and the apparatus includes:
an acquisition unit used to present a data processing task page, and acquire a SQL associated query statement in response to an input operation of a user on the data processing task page, the SQL associated query statement including a data source information of a plurality of first to-be-processed data tables, where at least two of the plurality of first to-be-processed data tables are from different data sources;
a conversion unit used to acquire a second to-be-processed data table based on the data source information, and replace the data source information of the first to-be-processed data table in the SQL associated query statement with a data table information corresponding to the second to-be-processed data table, so as to obtain an executable SQL query statement; and
an execution unit used to execute the executable SQL query statement to obtain a query result.

According to a fourth aspect of embodiments of the present disclosure, a computer-readable storage medium is provided, where an executable computer program in the storage medium, when executed by a processor, is capable of implementing the method according to any one of the above items.

According to the above-mentioned embodiments, after acquiring a SQL associated query statement, the present disclosure acquires to-be-processed data tables based on a data source information in the SQL associated query statement, converts the SQL associated query statement into an executable SQL query statement based on a data table information of the to-be-processed data tables, and executes the executable SQL query statement to obtain a query result. By converting the SQL associated query statement conforming to a pre-defined specification input by a user to obtain the executable SQL query statement, data located in different data sources may be fused together in real-time using SQL language.

It should be understood that the above general description and the following detailed description are only exemplary and explanatory, and do not limit the present disclosure.

### BRIEF DESCRIPTION OF THE DRAWINGS

The accompanying drawings herein, which are incorporated in and constitute a part of the description, illustrate embodiments consistent with the present disclosure and together with the description serve to explain principles in the present disclosure.

FIG. 1 shows a flowchart of a data processing method according to an embodiment of the present disclosure.

FIG. 2 shows a schematic diagram of a data processing task page according to an embodiment of the present disclosure.

FIG. 3 shows a schematic diagram of an operation flow of a data processing task according to an embodiment of the present disclosure.

FIG. 4 shows a schematic diagram of an added calculation column page according to an embodiment of the present disclosure.

FIG. 5 shows a schematic diagram of adding a new column to a query result according to an embodiment of the present disclosure.

FIG. 6 shows a schematic diagram of an output-to-database page according to an embodiment of the present disclosure.

FIG. 7 shows a flowchart of a task scheduling method according to an embodiment of the present disclosure.

FIG. 8 shows a schematic diagram of a task scheduling order according to an embodiment of the present disclosure.

FIG. 9A shows a schematic diagram of a first data integration page according to an embodiment of the present disclosure.

FIG. 9B shows a schematic diagram of a second data integration page according to an embodiment of the present disclosure.

FIG. 9C shows a schematic diagram of a third data integration page according to an embodiment of the present disclosure.

FIG. 10A shows a schematic diagram of a task scheduling page according to an embodiment of the present disclosure.

FIG. 10B shows a schematic diagram of a list of data integration tasks according to an embodiment of the present disclosure.

FIG. 10C shows a schematic diagram of a list of data processing tasks according to an embodiment of the present disclosure.

FIG. 11 shows a schematic diagram of an execution order according to an embodiment of the present disclosure.

FIG. 12 shows a schematic diagram of a template referencing process according to an embodiment of the present disclosure.

FIG. 13 shows a schematic diagram of a data processing apparatus according to an embodiment of the present disclosure.

### DETAILED DESCRIPTION OF EMBODIMENTS

Exemplary embodiments will be described in detail herein, with examples shown in the accompanying drawings. Where the following description refers to the drawings, the same numerals in different drawings refer to the same or similar elements unless otherwise indicated. The implementations described in the following exemplary embodiments do not represent all implementations consistent with the present disclosure. Instead, they are merely examples of apparatuses and methods consistent with some aspects of the present disclosure as detailed in the appended claims.

Data in different data sources may be stored in different forms and depend on different database management systems. However, in some scenarios, cross-data source queries need to be implemented, which involves consolidating data from different data sources to facilitate analysis. There are some technical challenges in cross-data source queries, mainly including the following aspects.

Heterogeneity of data sources: Different data sources have different storage structures and query syntaxes, requiring data conversion and syntax conversion.

Data security: In the process of a cross-data source query, it is necessary to ensure data security and data privacy, and operations such as permission verification and data encryption need to be performed on the data.

Performance problems: The cross-data source query involves data transmission and communication between different data sources, which may affect query performance.

Therefore, in order to consolidate data from different data sources for analysis, ETL tools are generally used to synchronize data from various data sources into a specific data warehouse, where analysis is performed. However, this method requires pre-synchronization of data, which involves a complex and time-consuming synchronization process. Additionally, the synchronized data becomes historical data, making it impossible to perform real-time data computation and analysis.

In view of this, the present disclosure provides a data processing method, which may consolidate data from different data sources based on a PySpark framework. That is, when a data processing task is performed, if the current data analysis involves data from different data sources, the method may be employed to fuse the required data from different data sources, abbreviated as cross-source fusing.

The present disclosure may be applied to a big data platform. The data source may be added to the big data platform by using information such as the IP, port, database name, and table name of the database in the data source, such that the big data platform may include at least two different data sources.

The following embodiments will describe the present disclosure with reference to the accompanying drawings.

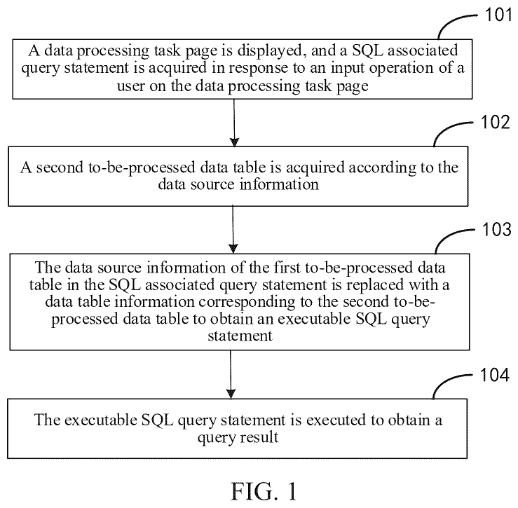

FIG. 1 shows a flowchart of a data processing method according to an embodiment of the present disclosure. As shown in FIG. 1, the method includes the following step 101 to step 104.

In step 101, a data processing task page is presented, and a SQL associated query statement is acquired in response to an input operation of a user on the data processing task page.

When to-be-processed data tables are located in different data sources, a user needs to input a SQL associated query statement in an agreed format, i.e., identifying a table name through a format of “data source. data table”. In the embodiment, the data source and the data table are referred to as a data source information, and the data source information is used to indicate a data table in a specified data source.

In order to distinguish from the subsequently mentioned to-be-processed data tables, the to-be-processed data tables in the SQL associated query statement input by the user are referred to as first to-be-processed data tables. The SQL associated query statement includes a data source information of a plurality of first to-be-processed data tables, where at least two of the plurality of first to-be-processed data tables are from different data sources.

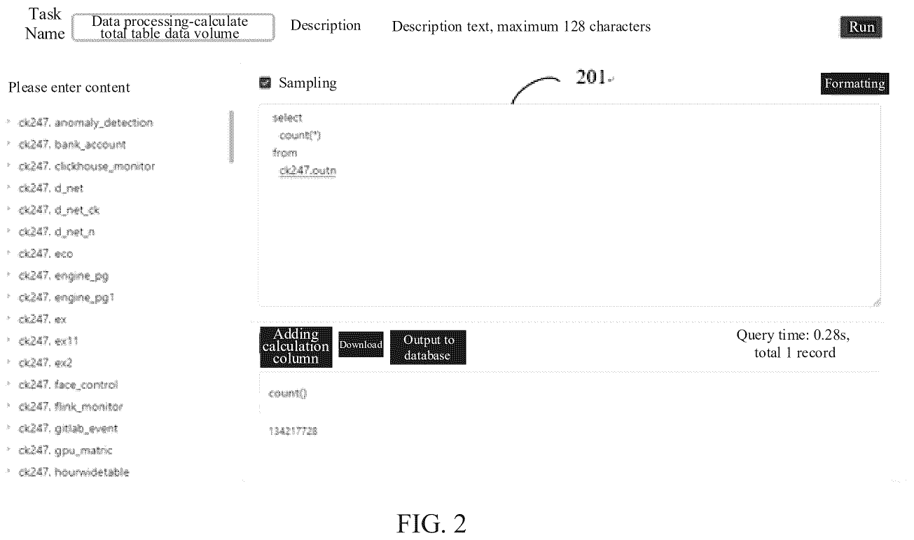

In an optional implementation, FIG. 2 shows a schematic diagram of a data processing task page according to an embodiment of the present disclosure. As shown in FIG. 2, the user may input a SQL associated query statement in a region 201.

Exemplarily, the SQL associated query statement input by the user conforms to the following specifications:
select * from (data source. data table) (left/right) join (data source.data table) on connection condition

The data source, the data table, and the connection condition may be determined according to actual needs.

When a plurality of data tables queried by the user belong to different data sources, the user may compose the table name of the first to-be-processed data table in the format of “data source. database” when inputting the SQL associated query statement. For the user, although this method is implemented through the PySpark framework, the user may input SQL language instead of Python code, which may reduce requirements for an operator.

Since the table name format in the SQL associated query statement input by the user is “data source. database”, the SQL associated query statement cannot be executed and needs to be converted through subsequent step 102 and step 103.

In step 102, a second to-be-processed data table is acquired according to the data source information.

After acquiring the SQL associated query statement input by the user, the SQL associated query statement may be verified. After passing the verification, SQL parsing is performed to obtain a data source information. In the PySpark framework, after acquiring the data source information, the data table in the data source is read as indicated by the data source information, so as to generate a distributed data collection (DataFrame) grouped by column names. In order to distinguish from the aforementioned to-be-processed data table, a to-be-processed data table generated by reading the data table in the data source is referred to as a second to-be-processed data table in the embodiments.

In step 103, the data source information of the first to-be-processed data table in the SQL associated query statement is replaced with a data table information corresponding to the second to-be-processed data table to obtain an executable SQL query statement.

The executable SQL query statement may be obtained by replacing the data source information representing the first to-be-processed data table in the SQL associated query statement with the data table information corresponding to the second to-be-processed data table.

In step 104, the executable SQL query statement is executed to obtain a query result.

According to the present disclosure, the PySpark framework is selected for cross-source fusion to perform data analysis and processing, a task is submitted to a Yarn cluster manager for execution, and Yarn is used to uniformly manage and schedule resources of all nodes in the cluster. In addition to the Yarn cluster manager, a Standalone cluster manager and a Mesos cluster manager may be used for management, which is not limited in the embodiments. The data processing method provided in the present disclosure may integrate data dispersed across different data sources for querying and analysis, thereby improving the query efficiency and the data analysis accuracy. Additionally, functions such as data sharing and collaborative analysis may be achieved, which helps optimize the efficiency of data management and the efficiency of application development.

The following embodiments will illustrate the data processing method of the present disclosure through specific examples.

Assume that MySQL is used as a business database to store a basic information of a user and an order information table of the user, and ClickHouse is used as a columnar storage database, which has the advantages of large data storage capacity and fast query speed, and is suitable for storing detailed data to be browsed by the user. Taking an example where the current requirement of a user is to calculate the daily user conversion rate of a store in the current month, the calculation logic is as follows: conversion rate=number of order-placing users/number of browsing users.

According to the above requirements, it is necessary to perform an association analysis between order data from MySQL and browsing data from ClickHouse by using the user information as an association field. In order to realize the association analysis, the user needs to write SQL in the format of “data source. data table” as the table name as required.

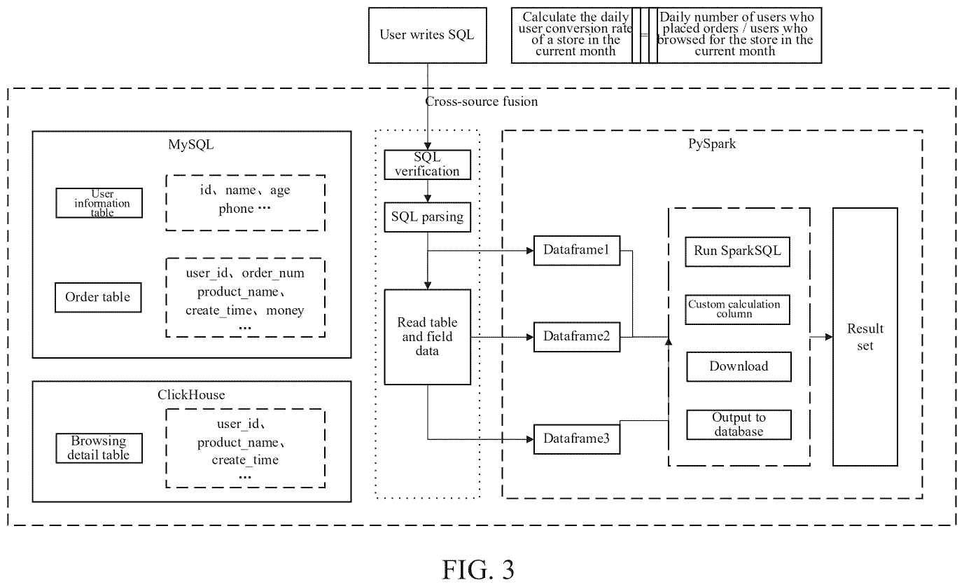

FIG. 3 shows a schematic diagram of an operation flow of a data processing task according to an embodiment of the present disclosure. As shown in FIG. 3, assuming that the data source mysql2 from MySQL and the data source ch3 from ClickHouse have been added to the big data platform, taking the user information table user_info and the browsing details table browse_details as an example, the writing format of the associated query syntax may be:
select * from mysql2.user_info left join ch3.browse_details on user info.id=browse_details.user id;

On the data processing task page, after the user writes the SQL associated query statement according to a rule, in response to the user clicking a run control, the SQL associated query statement is acquired and SQL verification is performed; after passing the verification, SQL parsing is performed, and the data source, the table name and the field name may be parsed according to a rule; based on the parsed information, in the PySpark framework, the data table in the corresponding data source is read to generate a corresponding DataFrame; for example, user_info in mysql2 is read to obtain a second to-be-processed data table, denoted as df1, and browse details in ch3 is read to obtain a second to-be-processed data table, denoted as df2.

The data source information of the first to-be-processed data table in the SQL associated query statement input by the user is replaced with the data table information corresponding to the second to-be-processed data table, that is, mysql2.user_info in the above-mentioned associated query statement is replaced with df1, and ch3.browse_details is replaced with df2, so as to obtain an executable SQL query statement: select * from df1 left join df2 on df1. id =df2.user id.

In the PySpark framework, the obtained executable SQL query statement is executed to generate a result dataset, i.e., a query result.

It should be noted that although both the cross-data source query and the cross-database query in the present disclosure involve accessing a plurality of data sources or a plurality of databases in a single query, there are the following differences between the two.

The cross-data source query generally refers to accessing a plurality of databases of diverse types or different data storage systems within a single query, such as a relational database, a NoSQL database, a text file, a Hadoop cluster, etc. These data sources may have different underlying storage structures and query syntaxes. Therefore, the cross-data source query requires technical means to connect these different data sources for unified data query and processing.

The cross-database query refers to accessing a plurality of databases of the same type within a single query, such as querying within the same MySQL instance. In this case, the storage structures and query syntaxes of the data are the same, thus the cross-database query is simple.

If two databases are deployed on different machines with different IPs and ports, the two databases belong to different data sources. For example, MySQL-10.10.111.111 and MySQL-47.22.22.22 are different data sources of the same type. The MySQL-10.10.111.111 data source contains a plurality of databases, such as bdmp, datax, information_schema and mysql111, and each database includes a plurality of data tables. The MySQL-47.22.22.22 data source also contains a plurality of databases, such as mysq1222.

In an example, the bdmp database includes a user_info data table, and the datax database includes a df data table. In this case, if a query involves the user_info data table in the bdmp database and the df data table in the datax database, the query involves different databases under the same data source and is a cross-database query.

In another example, the bdmp database includes a user info data table, and the mysql222 database includes a test data table. If a query involves both the test data table and the user_info data table, it indicates that the user_info data table from the MySQL-10.10.111.111 data source and the test data table from the MySQL-47.22.22.22 data source may be cross-source fused using the method provided in the present disclosure.

The present disclosure may be applied in the following scenarios.
1. When demonstrating to a user or conducting pre-analysis, synchronizing user data to the big data platform takes a lot of time. Accordingly, the user data may be accessed through the access method provided in the present disclosure.
2. Considering the data security, if a user does not granted data synchronization permissions, the access method in the present disclosure may be used to access the user data.
3. In a case where the user data performs update irregularly, if the updated data of the user is not updated synchronously, the analysis result will be inaccurate. The method in the present disclosure may be used to analyze the latest data stored by the user, which may improve the accuracy of the analysis result.

In some embodiments, after obtaining the query result, the method may further include: determining a processing condition for processing the query result based on the input operation of the user; processing the query result based on the processing condition to obtain a processing result; and adding a column to the query result and representing the processing result in the column.

As shown in FIG. 2, the data processing task page includes an calculation column adding control. The processing condition in the embodiment may be a user-defined calculation rule or a user-defined filtering condition.

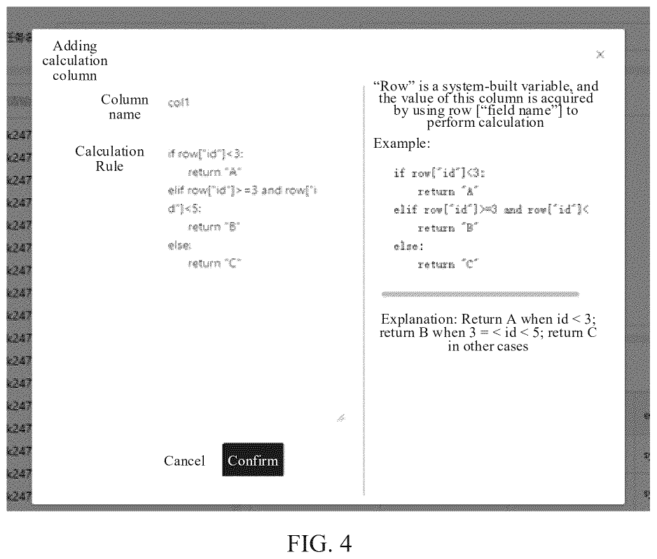

In an embodiment, in response to detecting that the calculation column adding control is triggered, an calculation column adding page as shown in FIG. 4 may be represented, and the calculation column adding page includes a calculation rule input box and a confirmation control. In response to detecting that the confirmation control is triggered, the Python code input by the user in the calculation rule input box is run. The use of custom calculated columns may enable the implementation of functions that are inconvenient or impossible to achieve using SQL statements. By acquiring a column name of a newly added column input by the user and the written Python code, the code segment is executed as a function after the code format verification is passed, so as to obtain the newly added column.

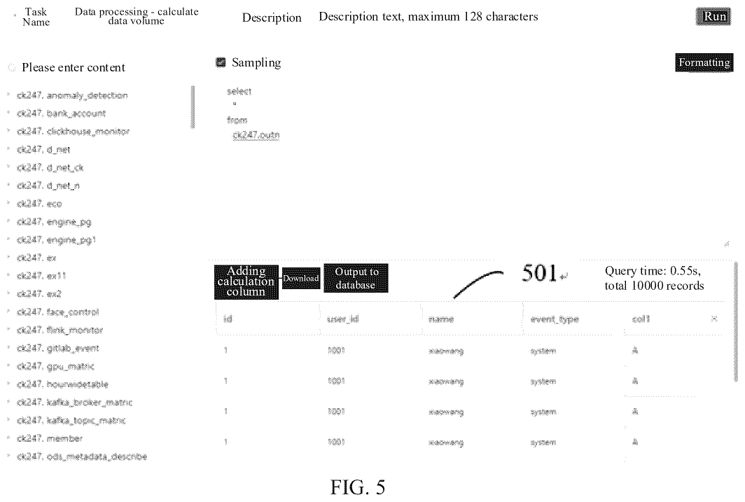

FIG. 5 shows a schematic diagram of adding a new column to a query result according to an embodiment of the present disclosure. As shown in FIG. 5, the query result is represented in a region 501 of the data processing task page, and a custom column, i.e., the rightmost col1 column, is added to the list corresponding to the query result.

In some embodiments, after obtaining the query result, the method may further include: determining a target database for storing the query result and a name of data table for storing the query result based on a configuration operation of the user; in a case that the target database does not include a data table corresponding to the name of data table, creating a data table corresponding to the name of data table; and in a case that the target database includes a data table corresponding to the name of data table, determining an output mode based on a selection operation of the user, and writing the query result into the data table of the target database in the output mode.

That is, the data processing task page includes an output-to-database control for determining a location where the query result is stored.

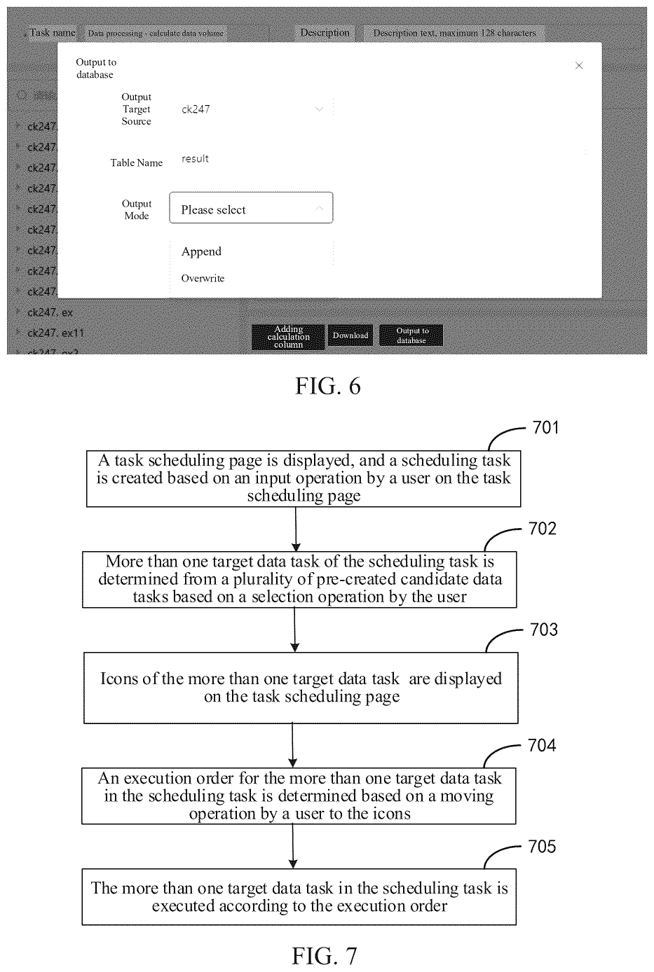

FIG. 6 shows a schematic diagram of an output-to-database page according to an embodiment of the present disclosure. In response to detecting that the output-to-database control is triggered, the output-to-database page as shown in FIG. 6 is represented, and configuration information, i.e., the target source, the table name and the output mode, input by the user on the output-to-database page is acquired. It is checked whether the table name configured by the user exists in the database; if the corresponding table does not exist, a table is created and the query result is stored therein; if the corresponding table exists, storage is performed according to the selected output mode. If an append mode is selected, the query result is appended to the table. If an overwrite mode is selected, the table is deleted, and a new table is created to write data.

In some embodiments, as shown in FIG. 2, the data processing task page further includes a download control. In response to the download control being triggered, the query result is output to a CSV file.

The current big data platform needs to determine the execution order of data tasks in a scheduling task based on a running script input by a developer, which results in high development costs and proneness to errors for a developer. In view of this, the present disclosure provides a task scheduling method, and based on the method, the user may drag icons corresponding to a plurality of data tasks in a target region to arrange the execution order of the data tasks in the scheduling task, reducing the workload of the developer and improving development efficiency.

The following embodiments will describe the task scheduling method with reference to the accompanying drawings.

FIG. 7 shows a flowchart of a task scheduling method according to an embodiment of the present disclosure. As shown in FIG. 7, the method includes the following step 701 to step 705.

In step 701, a task scheduling page is represented, and a scheduling task is created based on an input operation of a user on the task scheduling page.

In step 702, a plurality of target data tasks of the scheduling task is determined from a plurality of pre-created candidate data tasks based on a selection operation of the user.

The candidate data task includes a data processing task, and the data processing task is implemented by using the data processing method according to any one of the above embodiments.

In step 703, icons of the plurality of target data tasks are represented on the task scheduling page.

In step 704, an execution order for the plurality of target data tasks in the scheduling task is determined based on a moving operation of a user to the icons.

In step 705, the plurality of target data tasks in the scheduling task is executed according to the execution order.

The scheduling task in the embodiment may be an offline scheduling task. In an implementation, the icons of target data tasks may be in the form of cards, that is, each offline scheduling task may include a plurality of target data tasks, and the target data tasks have dependency relationships and may be executed serially or in parallel. After representing each target data task card on the task scheduling page, the execution order of the target data tasks may be defined by dragging the task cards.

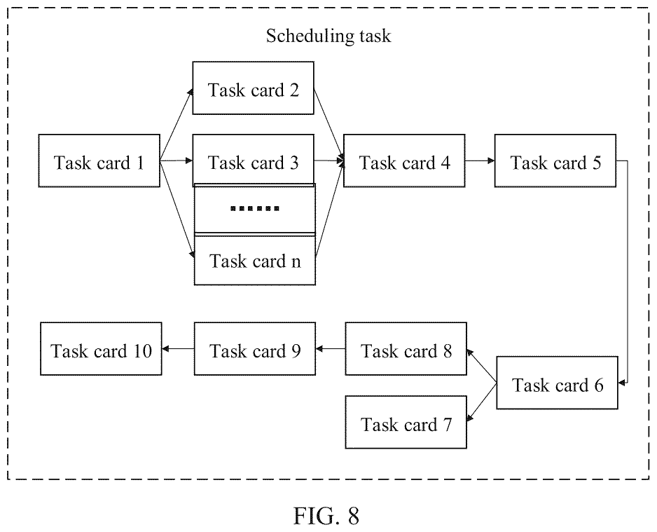

FIG. 8 shows a schematic diagram of a task scheduling order according to an embodiment of the present disclosure. As shown in FIG. 8, when one task card is positioned after another task card, it indicates sequential execution, and the next task is executed after the previous task is completed; when a plurality of task cards are dragged to the same vertical position, it indicates parallel execution, and the plurality of tasks may be executed simultaneously. The number of tasks executed in parallel is not fixed; for example, n tasks may be executed simultaneously. It will be noted that there are two scenarios for parallel task configuration: task 4 may only be executed after task 1 to task n are completed, while task 9 may start as soon as task 8 is completed.

Scenarios applicable to parallel execution may include: scenarios where a large number of tasks are going to be processed in the same scheduling task, with no dependencies between these tasks executed in parallel, and where rapid response to task requests is required. By executing a plurality of independent target data tasks in parallel, the task processing efficiency of the whole system may be improved, task processing time may be shortened, and the throughput and the response speed of the system may be enhanced.

In the embodiments, the candidate data task may further include, in addition to the data processing task, a data integration task, a shell script task, a Python script task, etc., and the above tasks may be added according to actual scheduling needs, which is not limited in the present disclosure.

The data processing task in the present disclosure may enable querying and associative calculations on data across various data sources by composing the SQL statement, support directly outputting the data analysis results to a database or downloading the data analysis results, and support the custom calculation column to implement complex logical functions. In the embodiment, the content related to the data processing task has been described in the data processing method, and will not be described in details here.

The data integration task in the present disclosure refers to data synchronization between data sources. The data sources may include a database, a file system, a service interface and a message queue, and data fusion across the data sources may be performed through the integration task. The main application scenarios of the data integration task are data synchronization, data integration (consolidation), data migration, and data exchange.

The shell script task in the present disclosure is code that implements a certain function through a set of shell syntax or commands. When periodic/non-periodic scheduling is required, it may be added to a scheduling task for execution by uploading a .sh file.

A Python script task in the present disclosure is code that is written in Python language to implement a certain function. When periodic/non-periodic scheduling is required, it may be added to a scheduling task for execution by uploading a .py file.

The following embodiments will introduce the data integration task.

In some embodiments, the method may further include: determining a data integration task name, a data source information and a data destination information based on an operation information of the user on a data integration page; and creating a data integration task corresponding to the data integration task name based on the data source information and the data destination information.

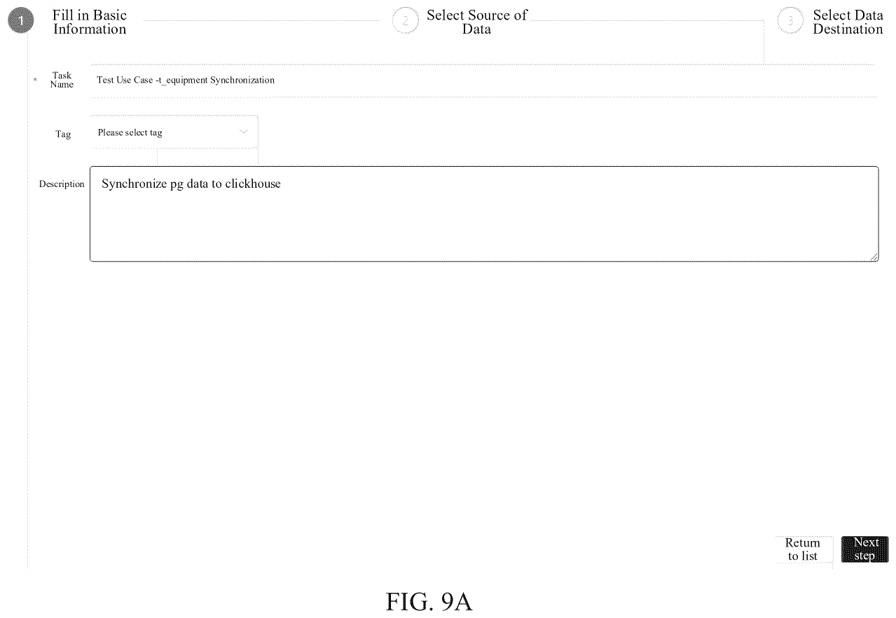

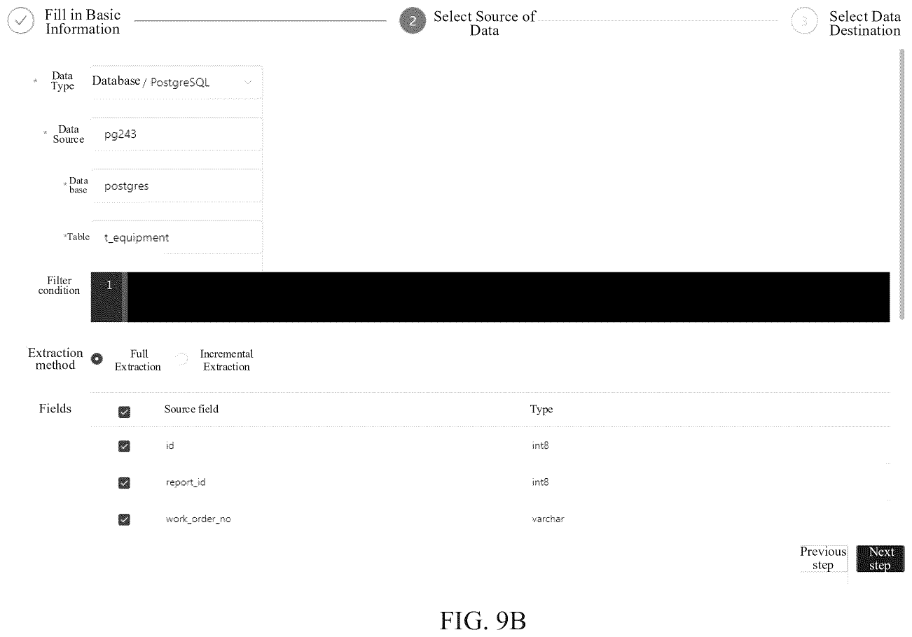

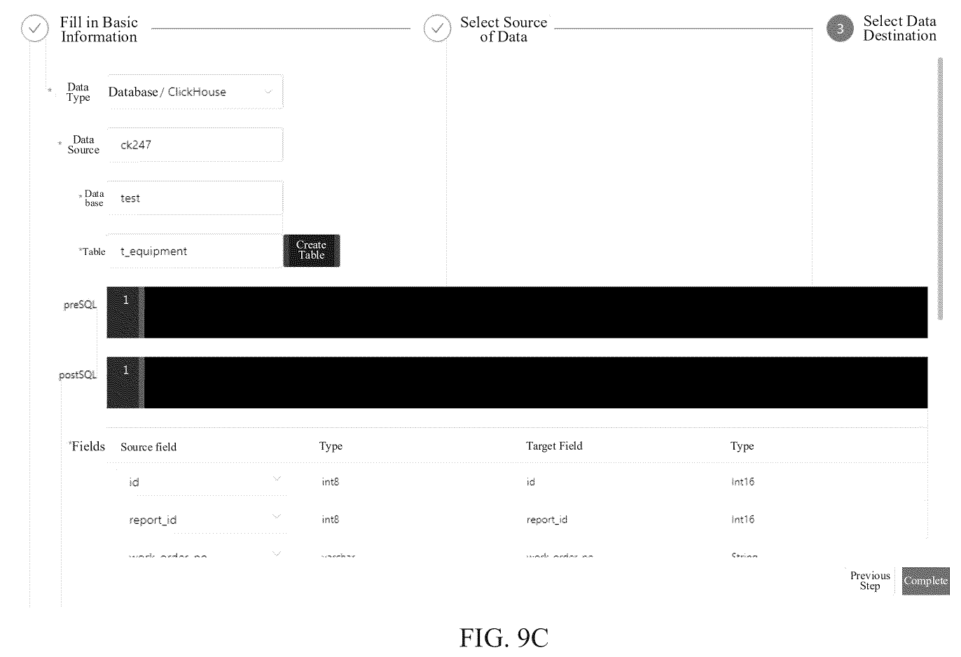

FIG. 9A, FIG. 9B, and FIG. 9C shows schematic diagrams of three data integration pages according to an embodiment of the present disclosure respectively, where a name, a tag information and a description information of a data integration task input by a user in the data integration page shown in FIG. 9A is acquired, a data source information selected by a user on the data source page shown FIG. 9B is acquired, and a data destination information selected by the user on the data destination page shown in FIG. 9C is acquired. A data integration task corresponding to the data integration task name is created based on the data source information and the data destination information.

A data integration task is created on a big data platform to synchronize data from one data source to another data source. Taking the synchronization of a specific data table from pg to a ClickHouse database as an example, the data integration task is configured, including: first, filling in a basic information, i.e., filling in a task name and a description on the data integration page shown in FIG. 9A; second, selecting a data source, i.e., selecting the table to be synchronized in the pg and checking data fields to be synchronized on the data source page shown in FIG. 9B; then selecting a data destination, i.e., selecting a destination table and corresponding fields in ClickHouse on the data destination page shown in FIG. 9C.

The task scheduling page in the embodiment includes a reference data integration task control and a reference data processing task control, a target data integration task is selected from the candidate data integration task via the reference data integration task control, and a target data processing task is selected from a candidate data processing task via the reference data processing task control.

In response to detecting that the reference data integration task control is triggered, a pre-created list of data integration tasks corresponding to the reference data integration task control is represented. In response to detecting that a data integration task in the list of data integration tasks is triggered, a corresponding data integration task card is represented in the target region of the task scheduling page.

In response to detecting that the reference data processing task control is triggered, a pre-created list of data processing tasks corresponding to the reference data processing task control is represented. In response to detecting that a data processing task in the list of data processing tasks is triggered, a corresponding data processing task card is represented in the target region of the task scheduling page.

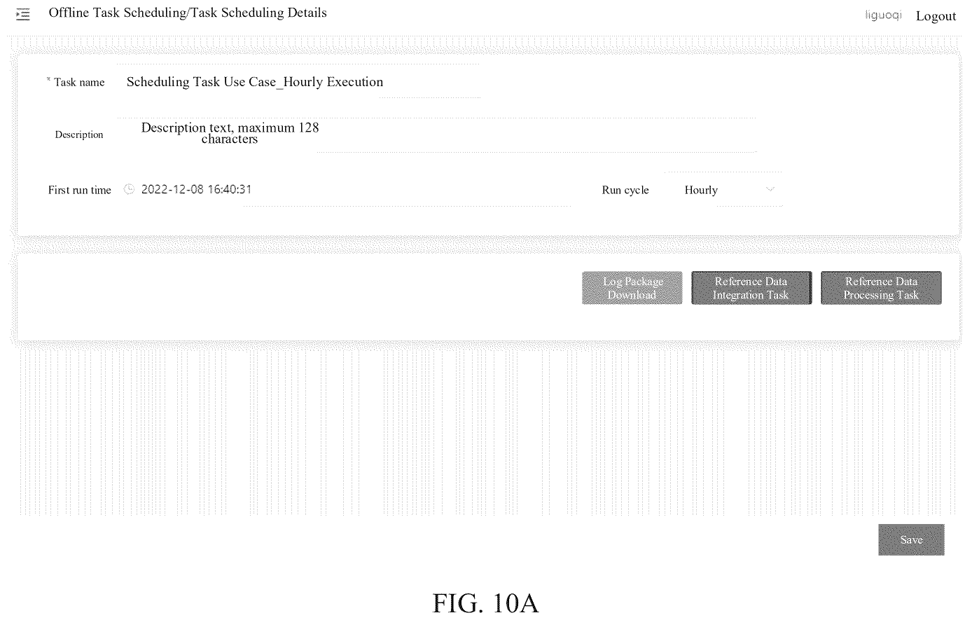

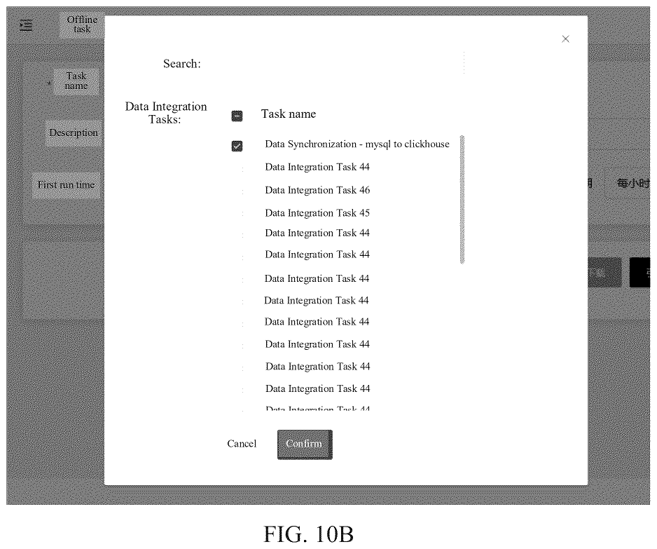

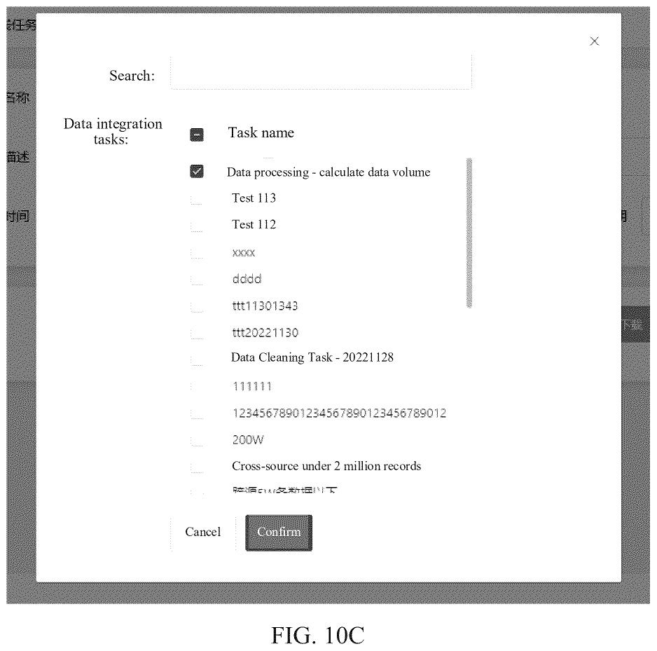

In an implementation, FIG. 10A shows a schematic diagram of a task scheduling page according to an embodiment of the present disclosure. The task scheduling page shown in FIG. 10A is represented, and a scheduling task is created based on the basic information input by the user, and a time instant at which the scheduling task is to run for the first time and a run cycle (e.g., hourly) selected by the user on the task scheduling page.

The task scheduling page shown in FIG. 10A includes a log package download control, a reference data integration task control, and a reference data processing task control.

When no data tasks are referenced in a task scheduling details page, the log package download control cannot be triggered; after referencing the target data task, the log package download control is triggered to allow packaging and downloading the running log content of all target data tasks to the local. This function is generally used to check task running status, or troubleshoot when tasks are abnormal.

In response to clicking the reference data integration task control, a list of created data integration tasks as shown in FIG. 10B may be represented. Selecting the required data integration tasks (a plurality of selections are allowed) may generate data task cards. By default, the data integration tasks are represented in reverse chronological order. When there are many data integration tasks, a search box may be used to find a target integration task.

In response to clicking the reference data processing task control, a list of created data processing tasks as shown in FIG. 10C may be represented. Selecting the required data processing tasks (a plurality of selections are allowed) generates data task cards. By default, the data processing tasks are represented in reverse chronological order. When there are many data processing tasks, a search box may be used to find a target processing task.

The order of data tasks is adjusted by dragging task cards based on dependencies, and in a case that it is detected that the user clicks a save control, the creation of the offline scheduling task is completed.

In some embodiments, based on a selection operation of the user on an icon, a development page of a target data task corresponding to the icon is represented; in response to detecting a modification operation of the user on the development page, a modified target data task is saved.

In a case that the icon is a data task card, the data task card includes a view control; in response to detecting that the view control is triggered, the development page corresponding to the data task card is represented; in response to detecting that the user modifies the target data task on the development page, the modified target data task is saved.

All data tasks in the embodiment are stored on the big data platform, and compared with the related art where commands need to be input to view the running status of data tasks, the embodiment allows modifying the data task by clicking the view control, facilitating user operations.

In some embodiments, the data task card may further include a manual run control; the method further includes: in response to detecting that the manual run control is triggered, running the data task corresponding to the data task card and representing a running result. The data task may be run individually without the need to upload a running script.

In some embodiments, the input operation includes a time instant at which the scheduling task is to run for the first time.

The executing the plurality of target data tasks in the scheduling task according to the execution order includes: executing, in response to a current time reaching the time instant at which the scheduling task is to run for the first time, the plurality of target data tasks in the scheduling task according to the execution order, and acquiring a running status of each target data task; in a case that the running status is an error status, stopping executing the scheduling task and returning a status of the scheduling task as an error status; and in a case that the respective target data tasks are executed in the execution order, returning the status of the scheduling task as a completed status.

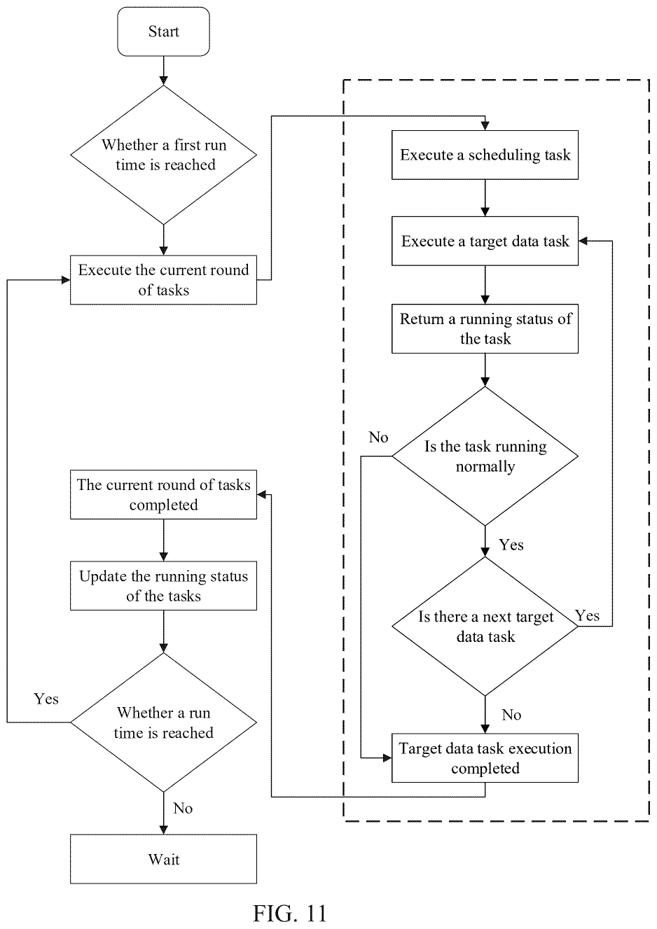

FIG. 11 shows a schematic diagram of an execution order according to an embodiment of the present disclosure. As shown in FIG. 11, the basic information of the offline scheduling task configured by the user, the running cycle, the first running time, all target data tasks included in each scheduling task, and the execution order of the target data tasks are stored in a specified data table; when a current time reaches the time instant at which the task is to run for the first time, this round of scheduling tasks is executed, including: traversing and executing the target data tasks, acquiring the running status of each target data task, and when the running status of a target data task is an error status, ending the scheduling task, stopping further execution, and returning the error status; when execution of the target data task is completed normally, executing the next target data task until all target data tasks are completed, and returning the completed status.

In some embodiments, the big data platform may further include a scheduling task template page, where the scheduling task template page includes a plurality of preset scheduling task template controls, and the method further includes: in response to detecting that any scheduling task template control is triggered, representing a scheduling task template corresponding to the scheduling task template control on the scheduling task template page; acquiring a configuration information for the scheduling task template by the user; and generating a scheduling task matching the configuration information based on the scheduling task template.

The scheduling task template may facilitate a user to quickly generate an offline scheduling task by referencing the template in the data analysis process, reducing repetitive work. Templates are divided into two types: user-generated templates and system-built-in templates. After creating an offline scheduling task, the user may select to click a generate template button to save the template to a template list for direct reference when performing a similar task next time. The system-built-in templates are based on common indicators for big data analysis, such as daily activity, monthly activity, online rate, conversion rate, etc., and the user may make a selection as needed.

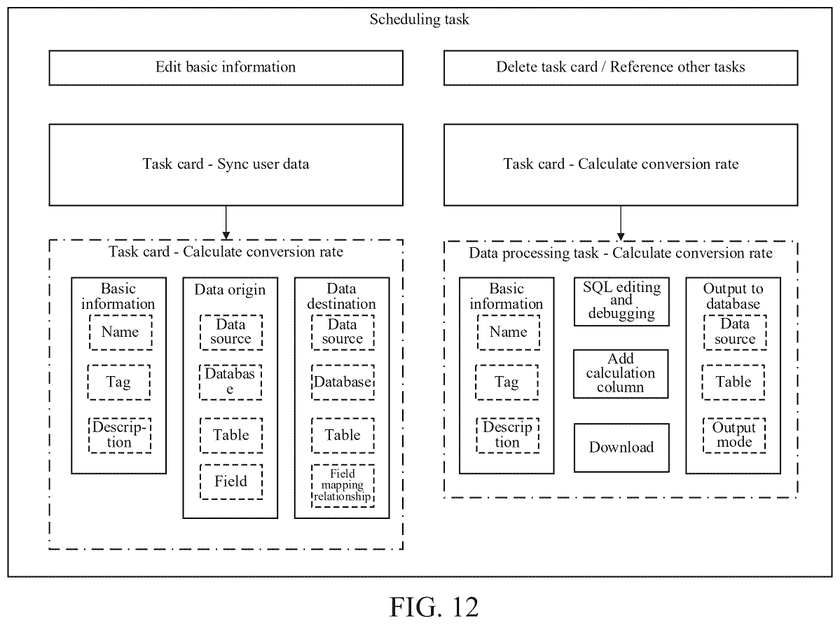

For example, taking referencing the calculating conversion rate as an example, FIG. 12 shows a schematic diagram of a process of referencing a template according to an embodiment of the present disclosure. As shown in FIG. 12, after referencing the scheduling task template, the user may modify the task name, the description, set the first run time and the running cycle, etc.; the scheduling task template is preset with task cards, and task cards may be added or deleted based on the selection operation of the user. The user may also enter the task card details page to modify the task content. For example, if the task is a data integration task, the content of the data source and the data destination may be modified to specify the target data source; if the task is a data processing task, the SQL code may be modified and run for debugging, and the content of add calculation column, output-to-database, etc. may be edited as needed, which is similar to the content in the previous embodiments and will not be described in detail here.

The present disclosure may enable a user to implement the full set of development processes for data analysis on the big data platform. The user may create and edit a data task, then enter the scheduling task page to reference a previously created task, configure the running cycle and the first run time, and realize periodic/non-periodic running of tasks. The running status of all scheduling tasks may be seen on the scheduling task list page. By clicking on a scheduling task to enter the scheduling task details page, all target data task cards may be seen. The execution order between the target data tasks may be adjusted by dragging the task cards, and the user may also click on the target data task card to directly jump to the task details page for viewing, editing, manual running, log viewing, etc. The data analysis process for a user is greatly facilitated, the threshold of big data development for the user is lowered, and easier maintenance and adjustments are achieved through a visual approach, thereby giving the user a better experience.

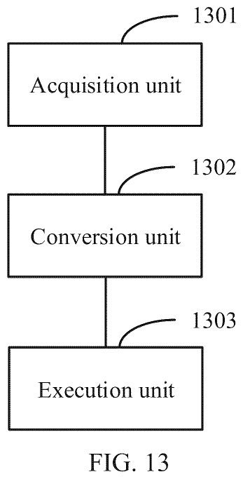

FIG. 13 shows a schematic diagram of a data processing apparatus according to an embodiment of the present disclosure. As shown in FIG. 13, the data processing apparatus provided by the present disclosure is applied to a big data platform including at least two different data sources, and the apparatus includes: an acquisition unit 1301 used to present a data processing task page, and acquire a SQL associated query statement in response to an input operation of a user on the data processing task page, the SQL associated query statement including a data source information of a plurality of first to-be-processed data tables, where at least two of the plurality of first to-be-processed data tables are from different data sources; a conversion unit 1302 used to acquire a second to-be-processed data table based on the data source information, and replace the data source information of the first to-be-processed data table in the SQL associated query statement with a data table information corresponding to the second to-be-processed data table, so as to obtain an executable SQL query statement; and an execution unit 1303 used to execute the executable SQL query statement to obtain a query result.

For the specific content executed by each of the above-mentioned units, reference may be made to the above-mentioned embodiments, which will not be described in detail here.

The present disclosure further provides a task scheduling apparatus applied to a big data platform, the apparatus including: a creation unit used to represent a task scheduling page, and create a scheduling task based on an input operation of a user on the task scheduling page; a determination unit used to determine a plurality of target data tasks of the scheduling task from a plurality of pre-created candidate data tasks based on a selection operation of the user, where the candidate data task includes a data processing task, and the data processing task is implemented by using the data processing method described in the above-mentioned embodiments; a represent unit used to represent icons of the plurality of target data tasks on the task scheduling page; a moving unit used to determine an execution order for the plurality of target data tasks in the scheduling task based on a moving operation of a user to the icons; and a scheduling unit used to execute the plurality of target data tasks in the scheduling task according to the execution order.

The device implementing the embodiment has a represent apparatus, and the represent apparatus may be: an electronic paper, a mobile phone, a tablet computer, a television, a notebook computer, a digital photo frame, a navigator, or any other product or component with a represent function.

It should be noted that in the accompanying drawings, the sizes of layers and regions may be exaggerated for clarity of illustration. Moreover, it may be understood that when an element or layer is described as being “on” another element or layer, the element or layer may be directly on the another element or layer, or an intermediate element or layer may exist. In addition, it may be understood that when an element or layer is described as being “under” another element or layer, the element or layer may be directly under the another element or layer, or one or more intervening layers or elements may exist. In addition, it can also be understood that when a layer or element is described as being “between” two layers or two elements, the layer or element may be the only layer or element between the two layers or two elements, or one or more intermediate layers or elements may also exist. Similar reference sings throughout indicate similar elements.

In the present disclosure, the terms “first” and “second” are only used for descriptive purposes, and may not be understood as indicating or implying relative importance. The term “a plurality of” refers to two or more, unless otherwise clearly defined.

Those skilled in the art will easily conceive of other embodiments of the present disclosure after considering the description and practicing the disclosure disclosed herein. The present disclosure is intended to cover any variations, uses, or adaptive changes of the present disclosure, and the variations, uses, or adaptive changes follow the general principles of the present disclosure and include common knowledge or conventional technical means in the art not disclosed by the present disclosure. The description and embodiments are only regarded as exemplary, and the true scope and spirit of the present disclosure are indicated by the following claims.

It should be understood that the present disclosure is not limited to the precise structure that has been described above and shown in the drawings, and various modifications and changes may be made without departing from the scope of the present disclosure. The scope of the present disclosure is only defined by the appended claims.

1. A data processing method, wherein the method is applied to a big data platform comprising at least two different data sources, and the method comprises:
presenting a data processing task page, and acquiring a SQL associated query statement in response to an input operation of a user on the data processing task page, the SQL associated query statement comprising a data source information of a plurality of first to-be-processed data tables, wherein at least two of the plurality of first to-be-processed data tables are from different data sources;
acquiring a second to-be-processed data table based on the data source information;
replacing the data source information of the first to-be-processed data table in the SQL associated query statement with a data table information corresponding to the second to-be-processed data table, so as to obtain an executable SQL query statement; and
executing the executable SQL query statement to obtain a query result.

2. The method according to claim 1, wherein the data processing method is implemented based on a PySpark framework.

3. The method according to claim 1, wherein after obtaining the query result, the method further comprises:
determining a processing condition for processing the query result based on the input operation of the user;
processing the query result based on the processing condition to obtain a processing result; and
adding a column to the query result and representing the processing result in the column.

4. The method according to claim 1, wherein after obtaining the query result, the method further comprises:
determining a target database for storing the query result and a name of data table for storing the query result based on a configuration operation of the user;
in a case that the target database does not comprise a data table corresponding to the name of data table, creating a data table corresponding to the name of data table; and
in a case that the target database comprises a data table corresponding to the name of data table, determining an output mode based on a selection operation by the user, and writing the query result into the data table of the target database in the output mode.

5. A task scheduling method, wherein the method is applied to a big data platform, and the method comprises:
presenting a task scheduling page, and creating a scheduling task based on an input operation of a user on the task scheduling page;
determining a plurality of target data tasks of the scheduling task from a plurality of pre-created candidate data tasks based on a selection operation of the user, wherein the candidate data task comprises a data processing task, and the data processing task is implemented by using the data processing method according to claim 1;
representing icons of the plurality of target data tasks on the task scheduling page;
determining an execution order for the plurality of target data tasks in the scheduling task based on a moving operation of a user to the icons; and
executing the plurality of target data tasks in the scheduling task according to the execution order.

6. The method according to claim 5, wherein the candidate data task further comprises a data integration task, and the method further comprises:
determining a data integration task name, a data source information and a data destination information based on an operation information of the user on a data integration page; and
creating a data integration task corresponding to the data integration task name based on the data source information and the data destination information.

7. The method according to claim 5, further comprising:
based on a selection operation by the user on the icon, representing a development page of a target data task corresponding to the icon; and
in response to detecting a modification operation of the user on the development page, saving a modified target data task.

8. The method according to claim 5, wherein the input operation comprises a time instant at which the scheduling task is to run for the first time; and
the executing the plurality of target data tasks in the scheduling task according to the execution order comprises:
executing, in response to a current time reaching time instant at which the scheduling task is to run for the first time, the plurality of target data tasks in the scheduling task according to the execution order, and acquiring a running status of each target data task;
in a case that the running status is an error status, stopping executing the scheduling task and returning a status of the scheduling task as an error status; and
in a case that the plurality of target data tasks are executed in the execution order, returning the status of the scheduling task as a completed status.

9. The method according to claim 5, further comprising:
representing, based on a selection operation of the user, a corresponding scheduling task template on a scheduling task template page;
acquiring a configuration information for the scheduling task template by the user; and
generating a scheduling task matching the configuration information based on the scheduling task template.

10. (canceled)

11. A non-transitory computer-readable storage medium, wherein an executable computer program in the storage medium, when executed by a processor, is configured to implement the method according to claim 1.

12. The non-transitory computer-readable storage medium according to claim 11, wherein the data processing method is implemented based on a Py Spark framework.

13. The non-transitory computer-readable storage medium according to claim 11, when executed by a processor, is further configured to: after the query result is obtained, determine a processing condition for processing the query result based on the input operation of the user;
process the query result based on the processing condition to obtain a processing result; and
add a column to the query result and representing the processing result in the column.

14. The non-transitory computer-readable storage medium according to claim 11, when executed by a processor, is further configured to: after the query result is obtained
determine a target database for storing the query result and a name of data table for storing the query result based on a configuration operation of the user;
in a case that the target database does not comprise a data table corresponding to the name of data table, create a data table corresponding to the name of data table; and
in a case that the target database comprises a data table corresponding to the name of data table, determine an output mode based on a selection operation by the user, and writing the query result into the data table of the target database in the output mode.

15. A non-transitory computer-readable storage medium, wherein an executable computer program in the storage medium, when executed by a processor, is configured to implement the method according to claim 5.

16. The non-transitory computer-readable storage medium according to claim 15, wherein the candidate data task further comprises a data integration task, and the non-transitory computer-readable storage medium, when executed by a processor, is further configured to:
determine a data integration task name, a data source information and a data destination information based on an operation information of the user on a data integration page; and
create a data integration task corresponding to the data integration task name based on the data source information and the data destination information.

17. The non-transitory computer-readable storage medium according to claim 15, when executed by a processor, is further configured to:
based on a selection operation by the user on the icon, represent a development page of a target data task corresponding to the icon; and
in response to detecting a modification operation of the user on the development page, save a modified target data task.

18. The non-transitory computer-readable storage medium according to claim 15, wherein the input operation comprises a time instant at which the scheduling task is to run for the first time; and
the non-transitory computer-readable storage medium when executed by a processor, is configured to: during the execution of the plurality of target data tasks in the scheduling task according to the execution order,
execute, in response to a current time reaching time instant at which the scheduling task is to run for the first time, the plurality of target data tasks in the scheduling task according to the execution order, and acquiring a running status of each target data task;
in a case that the running status is an error status, stop executing the scheduling task and returning a status of the scheduling task as an error status; and
in a case that the plurality of target data tasks are executed in the execution order, return the status of the scheduling task as a completed status.

19. The non-transitory computer-readable storage medium according to claim 15, when executed by a processor, is further configured to:
represent, based on a selection operation of the user, a corresponding scheduling task template on a scheduling task template page;
acquire a configuration information for the scheduling task template by the user; and
generate a scheduling task matching the configuration information based on the scheduling task template.
